(19) United States
(12) Patent Application Publication
(10) Pub. No.: US 2013/0262696 A1
(43) Pub. Date: Oct. 3, 2013

(54) PROXY SERVER APPARATUS, CLIENT TERMINAL APPARATUS, REMOTE ACCESS SYSTEM, TRANSFER CONTROL METHOD, ACCESS METHOD, AND RECORDING MEDIUM

(71) Applicant: FUJIFILM CORPORATION, Tokyo (JP)

(72) Inventor: Kentaro Watanabe, Tokyo (JP)

(73) Assignee: FUJIFILM Corporation, Tokyo (JP)

(21) Appl. No.: 13/851,889

(22) Filed: Mar. 27, 2013

(30) Foreign Application Priority Data
Mar. 30, 2012 (JP) 2012-081464

(51) Int. Cl. H04L 12/56

(52) U.S. Cl. CPC H04L 45/00
USPC 709/238

(57) ABSTRACT

A proxy server includes: a storage unit that stores a correspondence relationship between a one-time URL and a general URL in association with an accessible period during which access using the one-time URL, is permitted or a number of times the access is permitted; a restoration unit that restores the one-time URL to the general URL; a separation unit that separates the composite URL into the one-time URL and the general URL; an access authentication unit that performs access authentication using the one-time URI, in a case where the URL included in the access request is the one-time URL and using the one-time URL separated from the composite URL in a case where the URL included in the access request is the composite URL; and a transfer unit that transmits to the web server the access request and transfers a resource to the client terminal apparatus.

### BACKGROUND OF THE INVENTION

1. Field of the Invention

The present invention relates to a proxy server apparatus, a client terminal apparatus, a remote access system, a transfer control method, a recording medium storing a transfer control program, and an access method, and a recording medium storing an access program.

2. Description of the Related Art

With the spreading of high-performance portable terminals typified by smart phones, there is an increasing demand for browsing information or data in a company intranet. Remote access to various servers on the company intranet from an external network, such as the Internet, has been performed as a technique for meeting the demand.

Performing the remote access may cause the leakage of information. As a system for preventing the leakage of information, a system has been known in which the servers on the intranet are not open to an external network and a reverse proxy server relays communication between the external network and the intranet.

In the reverse proxy server system, for example, a path identifier (path name) obtained by encrypting all or some of the URLs for the resources of a web server is added to the host identifier (host name) of the reverse proxy server to generate a URL and the generated URL is distributed to the user. When the user transmits a request to access the URL from the client terminal, the reverse proxy server receives the access request. The URL is converted into the URL of the web server and the converted URL is transmitted to the web server. Then, the reverse proxy server transfers an access response to the access request from the web server to the client terminal. In this way, it is possible to prevent the client terminal from directly accessing the web server and only the authenticated user can access the web server.

Even in the reverse proxy server system in which the URL for the resources is encrypted into the path identifier, when the URL including the path identifier is disclosed to the third party, the third party can access the web server. In order to solve the problem, a so-called one-time URL, which permits only temporary access, has been known. In the one-time URL system, the period for which access can be performed using the one-time URL or the number of times access can be performed using the one-time URL is set to the reverse proxy server. Therefore, when the period has elapsed or the number of accesses is greater than the set value, access is not available.

JP2010-55200A discloses a reverse proxy server capable of designating the URL of a web server to access the web server. In the reverse proxy server disclosed in JP2010-55200A, a host identifier indicating the reverse proxy server, a user identifier indicating the user, and a directory identifier indicating a web server and the position of the resources on the web server are arranged in this order to generate a URL and the URL is transmitted from a client terminal to a reverse proxy server apparatus. Upon receiving the URL, the reverse proxy server apparatus performs authentication with the user identifier and generates a URL to be transmitted to the web server using the directory identifier.

### SUMMARY OF THE INVENTION

Meanwhile, a URL may be dynamically generated, for example, by a script described in an HTML file. In the dynamically generated URL, the host name of the web server is described as a host identifier and a path name designating the resources on the web server is described as a path identifier. Therefore, using such URL, it is difficult to access the web server on the intranet which implements the reverse proxy server system, and thus it is difficult to acquire resources.

In the case where the method disclosed in JP2010-55200A is used in order to solve the above-mentioned problems, an access to a web server is available. However, in the case where the host identifier indicating the reverse proxy server and the user identifier indicating the user are disclosed to the third party, it is easy for the third party to access the closed web server and thereby information may leak.

The present invention has been made in view of the above-mentioned problems and an object of the present invention is to provide a proxy server apparatus, a client terminal apparatus, a remote access system, a transfer control method, a recording medium storing a transfer control program, an access method, and a recording medium storing an access program capable of acquiring resources using a URL for a web server while preventing, for example, information leakage in a reverse proxy server system.

According to an aspect, a proxy server apparatus includes: a storage unit that stores a correspondence relationship between a one-time URL and a general URL in association with an accessible period during which access using the one-time URL is permitted or a number of times the access is permitted, with respect to each one-time URL, the one-time URL being generated by adding a path identifier generated by encrypting a position of a resource on the web server to a host identifier indicating the proxy server apparatus, the general URL being described so as to directly designate a position of the resource on the web server; a restoration unit that restores the one-time URL to the general URL corresponding to the one-time URL based upon content stored in the storage unit in a case where a URL included in an access request which is received from the client terminal apparatus is the one-time URL; a separation unit that, in a case where the URL included in the access request received from the client terminal apparatus is a composite URL, which is generated by adding the general URL to the one-time URL, separates the composite URL into the one-time URL and the general URL; an access authentication unit that performs access authentication using the one-time URL in a case where the URL included in the access request received from the client terminal apparatus is the one-time URL and using the one-time URL separated from the composite URL by the separation unit in a case where the URL included in the access request is the composite URL, the access authentication unit permitting an access to the web server by the client terminal apparatus in a case where the access request is within the accessible period or the number of times the access is permitted which are stored in the storage unit in association with the one-time URL; and a transfer unit that transmits to the web server the access request including the general URL restored by the restoration unit or the general URL separated from the composite URL in a case where the access authentication unit permits the access, and that transfers a resource, which is transmitted from the web server in response to the access request, to the client terminal apparatus.

The storage unit of the proxy server apparatus may store the accessible period with respect to each one-time URL, and the access authentication unit may extend the accessible period stored in the storage unit when the access is permitted.

According to another aspect of the present invention, a client terminal apparatus includes: a web browser that outputs an access request including a URL and displays a web page based upon a resource which is transmitted from the web server in response to the access request; a determining unit that determines whether the URL included in the access request from the web browser is a one-time URL, which is generated by adding a path identifier generated by encrypting a position of the resource on the web server to a host identifier indicating the proxy server apparatus, or a general URL, which is described so as to directly designate the position of the resource on the web server; a conversion unit that, in a case where the determining unit determines that the URL included in the access request from the web browser is the general URL, converts the access request into an access request including a composite URL, which is generated by adding the general URL to the one-time URL which is estimated to be valid among the one-time URLs acquired prior to determination by the determining unit; and a transmitting unit that transmits the converted access request in a case where the determining unit determines that the URL included in the access request is the general URL, or transmits the access request including the one-time URL in a case where the determining unit determines that the URL included in the access request is the one-time URL.

The client terminal apparatus may further include a storage unit that stores the one-time URL each time the web browser outputs the access request including the one-time URL. The conversion unit may use the one-time URL stored in the storage unit as the one-time URL which is estimated to be valid.

The determining unit may transmit the access request including the URL output from the web browser to an external network, and in the case where the determining unit receives a proper response to the access request transmitted to the external network is received, the determining unit may determine the URL included in the access request to be the one-time URL or a general URL for a server which is open to the external network. In the case where the determining does not receive the proper response, the determining unit may determine the URL included in the access request to be the general URL for the web server.

According to another aspect of the present invention, there is provided a remote access system including the proxy server apparatus and the client terminal apparatus.

According to another aspect of the present invention, a transfer control method includes: determining whether a URL included in an access request received from the client terminal apparatus on the first network is a one-time URL, which is generated by adding a path identifier generated by encrypting a position of a resource on the web server to a host identifier indicating the proxy server apparatus, or a composite URL, which is generated by adding a general URL which is described so as to directly designate the position of the resource on the web server to the one-time URL; restoring the URL included in the access request to the general URL corresponding to the path identifier of the one-time URL in a case where it is determined that the URL included in the access request is the one-time URL; separating the composite URL into the one-time URL, and the general URL in a case where it is determined that the URL included in the access request is the composite URL; performing access authentication using the one-time URL in a case where it is determined that the URL included in the access request is the one-time URL and using the one-time URL separated from the composite URL in a case where it is determined that the URL is the composite URL so as to permit an access to the web server by the client terminal apparatus in a case where the access request indicates access within an accessible period or a number of times the access is permitted which is set in association with the one-time URL; transmitting, to the web server, the access request including the general URL restored from the one-time URL or the general URL separated from the composite URL in a case where the access is permitted; and transferring a resource, which is transmitted from the web server in response to the access request, to the client terminal apparatus.

The transfer control method may further include extending the accessible period when the access is permitted.

According to another aspect of the present invention, an access method includes: outputting, from a web browser, an access request which includes a URL corresponding to a resource to be acquired; determining whether the URL included in the access request from the web browser is a one-time URL, which is generated by adding a path identifier generated by encrypting a position of a resource on the web server to a host identifier indicating the proxy server apparatus, or a general URL, which is described so as to directly designate a position of the resource on the web server; in a case where it is determined that the URL included in the access request is the general URL, converting the access request into an access request including a composite URL, which is generated by adding the general URL to the one-time URL which is acquired prior to the determining and is estimated to be valid; and transmitting the converted access request in a case where it is determined that the URL included in the access request is the general URL or transmitting the access request including the one-time URL in a case where it is determined that the URL included in the access request is the one-time URL.

In the transmission of the converted access request or the access request, the latest one-time URL output from the web browser may be used as the one-time URL which is estimated to be valid.

In the determination, the access request including the URL output from the web browser may be transmitted to an external network, and in the case where a proper response to the access request transmitted to the external network is received, it may be determined that the URL included in the access request is the one-time URL or a general URL for a server which is open to the external network. In the case where the proper response is not received, it may be determined that the URL included in the access request is the general URL for the web server.

According to another aspect of the present invention, there is provided a non-transitory computer-readable recording medium storing a transfer control program for relaying communication between a client terminal apparatus on a first network and a web server on a second network using a proxy server apparatus which is provided between the first network and the second network. The transfer control program causes the proxy server apparatus to perform: determining whether a URL included in an access request received from the client terminal apparatus on the first network is a one-time URL, which is generated by adding a path identifier generated by encrypting a position of a resource on the web server to a host identifier indicating the proxy server apparatus, or a composite URL, which is generated by adding a general URL which is described so as to directly designate the position of the resource on the web server to the one-time URL; restoring the URL included in the access request to the general URL corresponding to the path identifier of the one-time URL in a case where it is determined that the URL included in the access request is the one-time URL; separating the composite URL into the one-time URL and the general URL in a case where it is determined that the URL included in the access request is the composite URL; performing access authentication using the one-time URL in a case where it is determined that the URL included in the access request is the one-time URL and using the one-time URL separated from the composite URL in a case where it is determined that the URL included in the access request is the composite URL, so as to permit an access to the web server by the client terminal apparatus in a case where the access request indicates access within an accessible period or a number of times the access is permitted which is set in association with the one-time URL; transmitting, to the web server, the access request including the general URL restored from the one-time URL or the general URL separated from the composite URL in a case where the access is permitted; and transferring a resource which is transmitted from the web server in response to the access request to the client terminal apparatus.

The transfer control program may cause the proxy server apparatus to further perform extending the accessible period when the access is permitted.

According to another aspect of the present invention, there is provided a non-transitory computer-readable recording medium storing an access program that allows a client terminal apparatus on a first network to access a web server on a second network through a proxy server apparatus which is provided between the first network and the second network. The access program causes the client terminal apparatus to perform: outputting, from a web browser, an access request which includes a URL corresponding to a resource to be acquired; determining whether the URL included in the access request from the web browser is a one-time URL, which is generated by adding a path identifier generated by encrypting a position of a resource on the web server to a host identifier indicating the proxy server apparatus, or a general URL, which is described so as to directly designate a position of the resource on the web server; in a case where it is determined that the URL included in the access request is the general URL, converting the access request into an access request including a composite URL generated by adding the general URL to the one-time URL which is acquired prior to the determining and is estimated to be valid; and transmitting the converted access request in a case where it is determined that the URL included in the access request is the general URL or transmitting the access request including the one-time URL in a case where it is determined that the URL included in the access request is the one-time URL.

In the transmission of the converted access request or the access request, the latest one-time URL output from the web browser may be used as the one-time URL which is estimated to be valid.

In the determination, the access program may cause the client terminal apparatus to transmit the access request including the URL output from the web browser to an external network, and in the case where a proper response to the access request transmitted to the external network is received, the access program may cause the client terminal apparatus to determine that the URL included in the access request is the one-time URL or a general. URL for a server which is open to the external network. In the case where the proper response is not received, the access program may cause the client terminal apparatus to determine that the URL included in the access request is the general URL for the web server.

According to the present invention, in the case where the general URL which is described so as to directly designate the position of the resources on the server is output, the access request including the composite URL, which generated by adding the general URL to the one-time URL acquired so far and being estimated to be valid, is transmitted. Then, access authentication is performed using the one-time URL. In the case where the authentication succeeds, the general URL is transferred to the server. Therefore, it is possible to acquire resources from the general URL. In addition, even in the case where the composite URL is disclosed to another person, information leakage is less likely to occur since the period for which access can be performed with the one-time URL or the number of times access is permitted is limited. Furthermore, since the one-time URL acquired so far is used, there is no need to perform communication for authentication, and thus it is possible to reduce the volume of communication.

### BRIEF DESCRIPTION OF THE DRAWINGS

FIG. 1 is a schematic diagram illustrating a remote access system according to an embodiment of the present invention.

FIG. 2 is a block diagram illustrating the structure of a main part of a proxy server.

FIG. 3 is a diagram illustrating one-time LTRLs registered in a database and various kinds of information corresponding thereto.

FIG. 4 is a block diagram illustrating the structure of a main part of a client terminal.

FIG. 5 is a flowchart illustrating a communication process among a client terminal, a proxy server, and a web server.

FIG. 6 is a flowchart illustrating a communication process among the client terminal, the proxy server, and the web server when a new web page is displayed.

FIG. 7 is a flowchart illustrating an access authentication process.

FIG. 8 is a flowchart illustrating another method of determining a one-time URL and a general LTRL.

FIG. 9 is a flowchart illustrating an example of the extension of an accessible period whenever access is permitted.

FIG. 10 is a flowchart illustrating an example in which access to the one-time URL is limited by the number of times access is permitted.

### DESCRIPTION OF TAT PREFERRED EMBODIMENTS

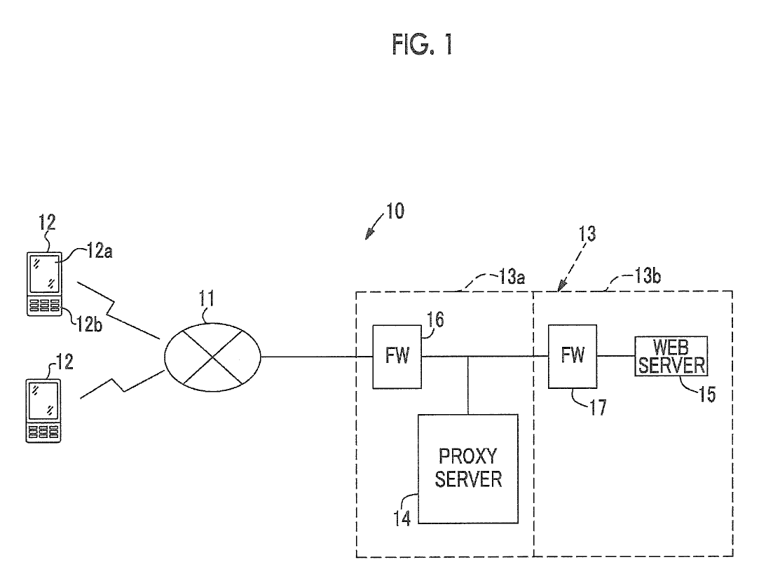

FIG. 1 shows a remote access system 10 according to an embodiment of the present invention in which a client terminal 12 which is arranged on a network 11 accesses a web server 15 through a proxy server 14 in an intranet 13 and browses a web page provided by the web server 15.

The intranet 13 is a network which is constructed using Internet technology and is constructed in, for example, a company. The intranet 13 includes the servers 14 and 15 and first and second firewalls (hereinafter, referred to as FWs) 16 and 17 which prevent illegal access to the web server 15. The intranet 13 is connected to the network 11, which is an external network, through the first FW 16 and the second FW 17 is connected to the rear side of the first FW 16. A network region 13a which is called a DMZ (Demilitarized Zone) is provided between the first FW 16 and the second FW 17 and the inside of the second FW 17 is the internal network 13b which is isolated by the network region 13a. The internal network 13b is a second network.

The proxy server 14 is a reverse proxy server that is provided in the network region 13a and relays communication between the client terminal 12 on the network 11, which is the first network, and the web server 15 on the internal network 13b. The first FW 16 permits only predetermined communication between the network 11 and the proxy server 14. Examples of the permitted predetermined communication include communication for user authentication and HTTPS (Hypertext Transfer Protocol over Secure Socket Layer) communication for browsing the web page. The second FW 17 permits only the communication between the web server 15 and the proxy server 14.

The proxy server 14 converts an HTTPS request, which is an access request transmitted from the client terminal 12 to the proxy server 14, into an HTTPS request for the web server 15 and transmits the converted HTTPS request to the web server 15. In addition, the proxy server 14 transfers an HTTPS response which is transmitted from the web server 15 in response to the HTTPS request to the client terminal 12 which is an HTTPS request transmission source. The proxy server 14 has, for example, an authentication function and a function of generating and restoring a one-time URL. The web server 15 stores resources (for example, HTML files and images) for displaying the web page and transmits the resources designated by a URL (path) in the HTTPS request as the HTTPS response.

For simplicity of description, the transmission of the HTTPS request (an HTTPS request described in a predetermined format) including the URL designating the resources is simply referred to as the “transmission of a URL”.

For example, “proxy.aaa.jp” is given as a host name to the proxy server 14, and this host name is open to the network 11. Therefore, in the case where an URL having the host name as a host identifier is transmitted from the network 11, the proxy server 14 can receive the URL. On the other hand, “w⁻ww.bbb.jp” is given as a host name to the WEB server 15 This host name is valid only in the intranet 13, and is not open to the network 11. Therefore, in the case where a URL having the host name of the web server 15 as the host identifier is transmitted from the network 11, it does not reach the web server 15 and the intranet 13.

The client terminal 12 is connected to the intranet 13 through the network 11. For example, a smartphone having the function of a web browser is used as the client terminal 12. The client terminal 12 includes, for example, a display 12a and a keyboard 12b. A web page is displayed on the display 12a by the web browser, The keyboard 12b is operated to input, for example, various kinds of instructions or passwords for authentication. The display 12a is a touch screen and the user can touch the display 12a to input characters or an instruction to move to the linked web page.

The client terminal 12 is not limited to the smart phone, but any apparatus may be used as the client terminal 12 as long as it can be connected to the intranet 13. For example, various kinds of terminal apparatuses, such as mobile phones, personal digital assistants (PDAs), and notebook or desktop computers, may be used.

Any network may be used as the network 11 as long as it is connected such that the client terminal 12 and the intranet 13 can communicate with each other. For example, the Internet, a leased line, and a mobile phone line may be mixed with each other. The external network is not limited to the released network, such as the Internet, but may be an intranet which is constructed in the company, such as the intranet 13.

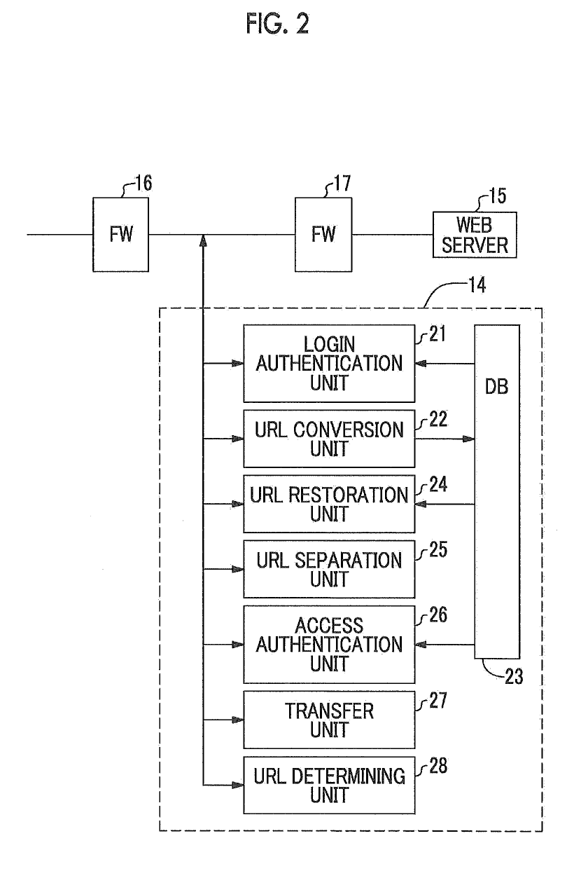

As shown in FIG. 2, the proxy server 14 includes a login authentication unit 21, a URL conversion unit 22, a database (DB) 23, a URL restoration unit 24, a URL separation unit 25, an access authentication unit 26, a transfer unit 27, and a URL determining unit 28. The proxy server 14 is a computer having a communication function and a CPU of the computer executes a program to implement the functions of the units 21 to 28,

The login authentication unit 21 communicates with the client terminal 12 to perform login authentication for checking whether an access user is an authenticated user before the web page is provided. The login authentication process compares the user ID and the password received from the client terminal 12 with the registered user ID and password and determines that the access user is the authenticated user when the user IDs and the passwords are identical to each other. In the case where it is checked that the access user is the authenticated user, the URL of an initial page (web page) is transmitted to the client terminal 12.

The URL conversion unit 22 generates a one-time URL corresponding to a URL (hereinafter, referred to as a general URL), which is described so as to directly designate the position of resources on the web server 15. In the one-time URL generated by the URL conversion unit 22, the host name of the proxy server 14 is described as a host identifier in the URL and an encrypted path identifier is described as a path identifier. In addition, an accessible period is set to the one-time URL in order to limit the period for which access is available. The encrypted path identifier is a path identifier generated by encrypting the general URL and is generated by the URL conversion unit 22. In the encryption, random numbers are used to generate ID numbers with several digits which are not related to the general URL and are not duplicated. Meanwhile, the encrypted path identifier may be generated by other methods or in other formats.

For example, in the case where the general URL is “https://www.bbb.jp/abc/about.html”and the encrypted path identifier obtained by encrypting the general URL is “/id56461513”, a one-time URL “https://proxy.aaa.jp/id56461513” is generated since the host identifier (host name) of the proxy server 14 is “proxy.aaa.jp”.

The accessible period set to the one-time URL is, for example, 20 minutes from the generation of the one-time URL. After the accessible period has elapsed, access with the one-time URL is not available. The length of the accessible period may be arbitrarily set.

The URL conversion unit 22 converts the general URL of the initial page transmitted after the login authentication into a one-time URL. In addition, the URL conversion unit 22 converts the general URL described in the resources, such as an HTML file to be transmitted to the client terminal 12, into a one-time URL and rewrites the one-time URL over the general URL. In this case, the general URL includes a URL configured by only the path identifier described in a relative path.

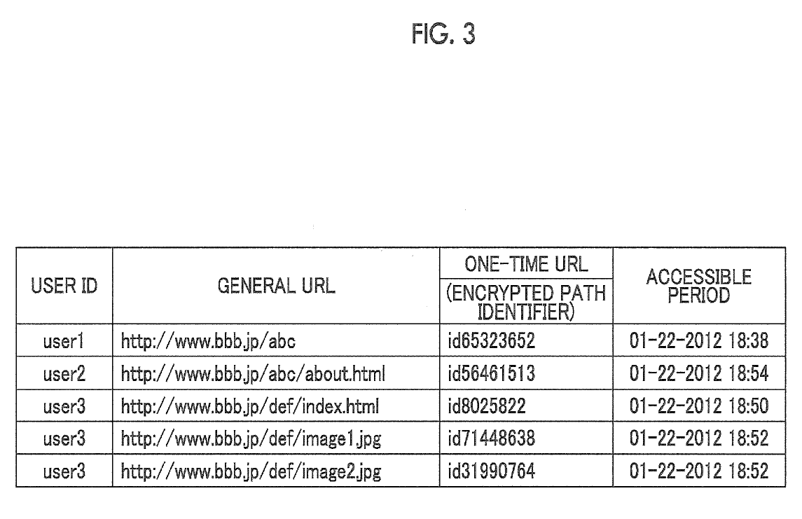

The database 23 is a storage unit which stores the correspondence relationship between the one-time URL and the general URL and the accessible period set to the one-time URL so as to be associated with each of the generated one-time URLs. For example, as shown in FIG. 3, the general URL, which is the source of the encrypted path identifier in the one-time URL generated by the URL conversion unit 22, and the accessible period set thereto are registered for each encrypted path identifier in the database 23. It is possible to restore the one-time URL (encrypted path identifier) to the general URL or determine whether access with the one-time URL is valid, with reference to the content of the database 23.

In this example, a user ID indicating the user to which the encrypted path identifier is issued is registered so as to correspond to the encrypted path identifier. However, for example, a MAC address or an ID number for identifying the client terminal 12 to which the one-time URL is issued may be registered and used for access authentication. In addition, only the encrypted path identifier, not the one-time URL, is registered. However, the one-time URL may also be registered.

In the case where the URL received from the client terminal 12 is the one-time URL, the URL restoration unit 24 extracts the original URL corresponding to the encrypted path identifier in the one-time URL from the database 23. In this way, the URL restoration unit 24 restores the one-time URL to the general URL before conversion.

In the case where the URL received from the client terminal 12 is an URL in a composition format (hereinafter, referred to as a composite URL), the URL separation unit 25 separates the composite URL into the one-time URL and the general URL. The composite URL has, for example, a format in which a general URL “https://www.bbb.jp/abc/hello.html” follows a one-time URL “https ://proxy.aaa.jp/id5688884” with a delimiter “?url=” interposed therebetween, like “https://proxy.aaa.jp/id5688884?url=https://www.bbb.jp/abc/hello.html”. In this example, “?url=” is used as the delimiter. However, any delimiter may be used as long as it can distinguish the one-time URL and the general URL. For example, “/” may be used as the delimiter.

The access authentication unit 26 performs access authentication using the one-time URL. The access authentication unit 26 permits the transfer unit 27 to transfer the general URL to the web server 15, that is, an access to the web server 15 only in the case where the accessible period has not elapsed, with reference to the accessible period in the database 23 corresponding to the encrypted path identifier in the one-time URL. In the case where the URL received from the client terminal 12 is the one-time URL, the access authentication unit 26 performs access authentication using the encrypted path identifier in the one-time URL. In the case where the URL received from the client terminal 12 is the composite URL, the access authentication unit 26 performs access authentication using the encrypted path identifier in the one-time URL separated by the URL separation unit 25.

In this example, the access authentication is performed on the basis of the accessible period. However, it may be determined whether the ID number of the client terminal 12 or the user ID which transmits the HTTPS request is identical to the destination of the one-time URL and authentication may be performed on the basis of the determination result.

In the case where the access authentication unit 26 permits the transfer, the transfer unit 27 transmits the general URL restored by the URL restoration unit 24 or the general URL which is separated from the composite URL by the URL separation unit 25 to the web server 15. In addition, the transfer unit 27 transmits the HTTPS response from the web server 15, that is, the resources designated by the general URL to the client terminal 12.

The URL determining unit 28 determines whether the URL which has been transmitted from the client terminal 12 and then received by the proxy server 14 is the one-time URL or the composite URL. For example, a URL in which there is no predetermined delimiter after the encrypted path identifier may be determined to be the one-time URL and a URL (general URL) in which a predetermined delimiter follows the encrypted path identifier may be determined to be the composite URL.

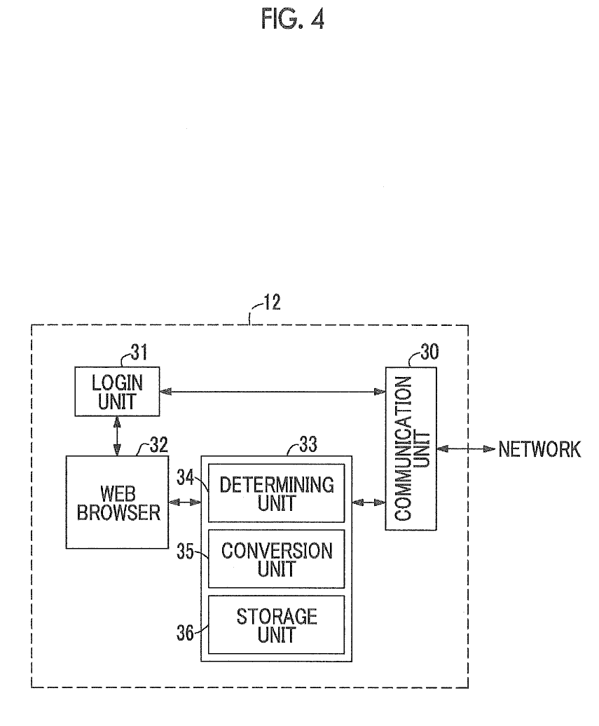

As shown in FIG. 4, the client terminal 12 includes a communication unit 30, a login unit 31, a web browser 32, and a terminal proxy unit 33. The CPU of the client terminal 12 executes a program to implement the functions of the login unit 31, the web browser 32, and the terminal proxy unit 33.

The communication unit 30 communicates with the proxy server 14 through the network 11 using a predetermined protocol. The login unit 31 communicates with the login authentication unit 21 through the communication unit 30. A user ID and a password input screen when the browsing of the web page starts are displayed on the display 12a by the login unit 31. In addition, the input user ID and password are transmitted to the login authentication unit 21 by the login unit 31. The login unit 31 receives the one-time URL of the initial page which is transmitted from the proxy server after the login authentication unit 21 performs authentication, starts a web browser, and displays the web page designated by the one-time URL.

The web browser 32 draws the image based on the resources acquired from the web server 15 and displays the web page on the display 12a. When the resources are acquired, the web browser 32 outputs the URL (HTTPS request) of the resources to be acquired. Examples of the output URL include the one-time URL received by the login unit 31, a URL, which is a link destination incorporated into the web page which is being displayed, and a URL which is dynamically generated by a script such as JavaScript (registered trademark). In some cases, the URL, which is the link destination incorporated into the web page, is the one-time ⁻URL rewritten by the URL conversion unit 22 and the URL which is dynamically generated by, for example, a script is the general URL.

The terminal proxy unit 33 has a function of relaying the communication between the web browser 32 and the communication unit 30 and a function of converting the general URL into the composite URL. The terminal proxy unit 33 includes a determining unit 34, a conversion unit 35, and a storage unit 36 in order to convert the general URL into the composite URL. The determining unit 34 determines whether the URL from the web browser 32 is the general URL or the one-time URL. In the determination, for example, in the case where the host identifier in the URL is of the proxy server 14, the URL may be determined to be the one-time URL. In the other cases, the URL may be determined to be the general URL. The host identifier of the proxy server 14 used for determination may be extracted from the one-time URL acquired by the login unit 31 or it may be predetermined.

The conversion unit 35 converts the general URL into the composite URL and outputs the composite URL. Therefore, in the case where the web browser 32 outputs the general URL, the composite URL is transmitted from the communication unit 30. In the case where the determination result of the determining unit 34 is the general URL, the conversion unit 35 adds the general URL to the one-time URL which is estimated to be valid, as described above, thereby generating the composite URL. The conversion unit 35 uses the one-time URL stored in the storage unit 36 as the one-time URL which is estimated to be valid.

In practice, the conversion unit 35 converts the general URL into the composite URL by rewriting the general URL described in the HTTPS request to the composite URL. In addition, the determining unit 34 performs the determination process with reference to the URL described in the HTTPS request.

The storage unit 36 stores the one-time URL used to generate the composite URL. The storage unit 36 updates the stored content to the one-time URL each time the determining unit 34 determines that the URL is the one-time URL, that is, each time the web browser outputs the one-time URL. In this way, the storage unit 36 stores the latest one-time URL which is from the web browser 32 to the proxy server 14. Therefore, the conversion unit 35 generates the composite URL using the latest one-time URL transmitted by the web browser 32 as the one-time URL which is estimated to be valid.

In this example, the latest one-time URL transmitted by the web browser 32 is used as the one-time URL which is estimated to be valid. Any one-time URL may be used as long as it is estimated to be valid. For example, the one-time URL of the web page which is being displayed on the display 12a or the one-time URL, which is the link destination incorporated into the web page which is being displayed, may be used as the one-time URL which is estimated to be valid. In addition, the one-time URL received after login authentication may be used as the one-time URL which is estimated to be valid.

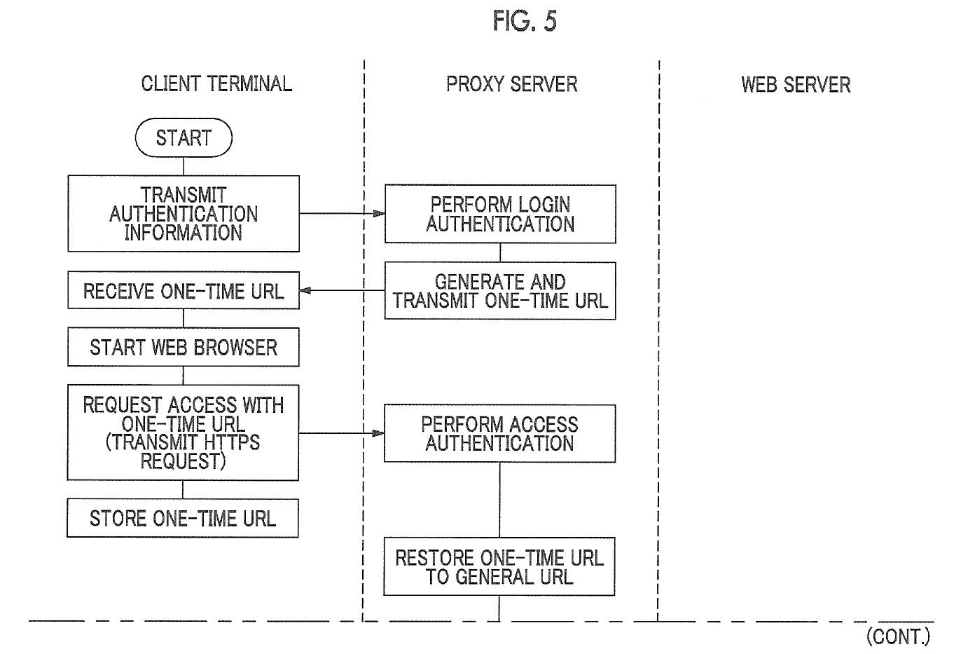

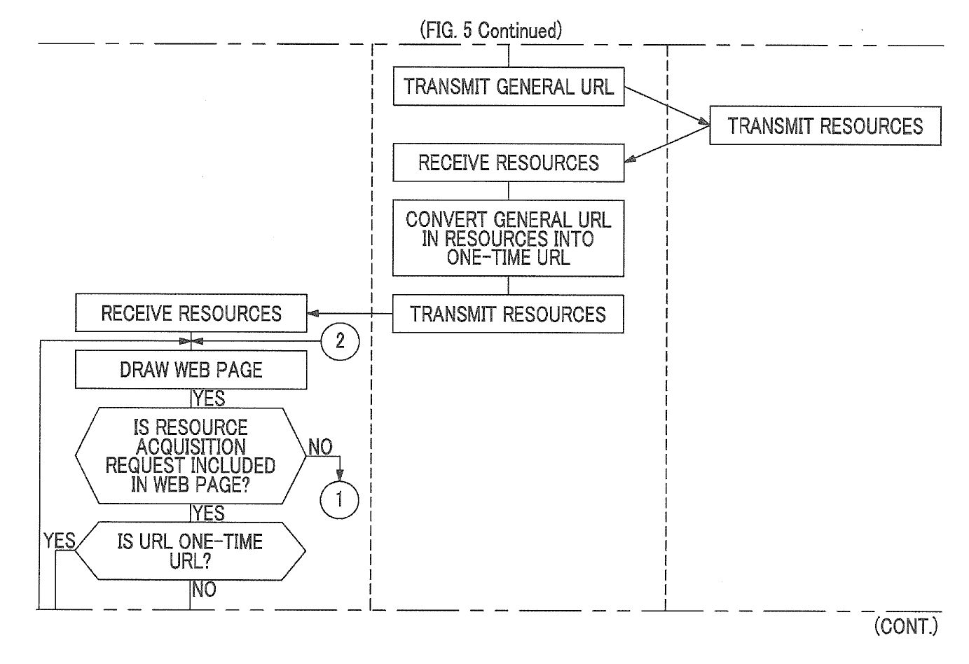

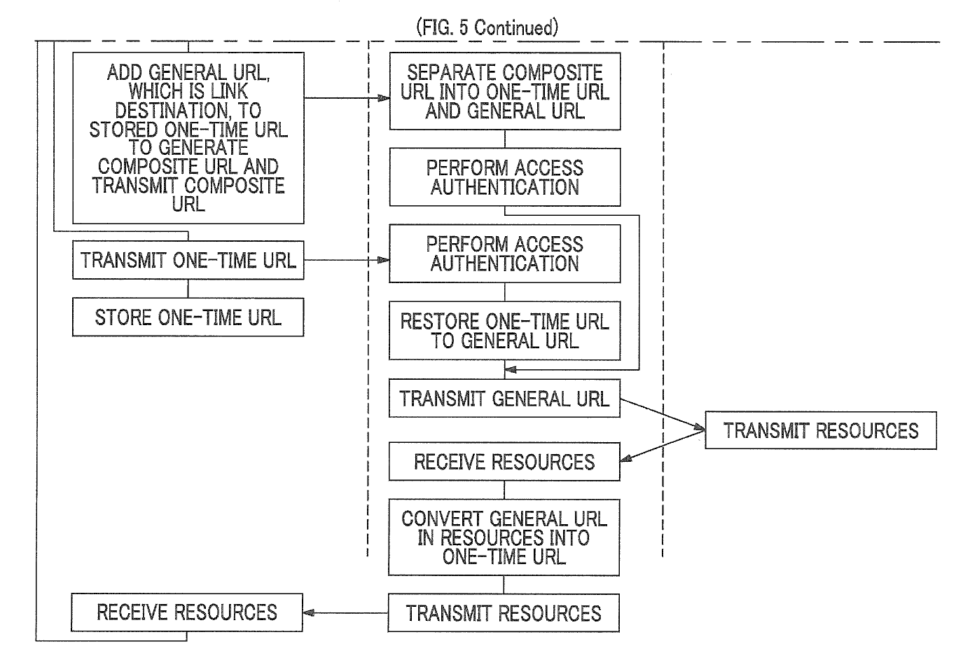

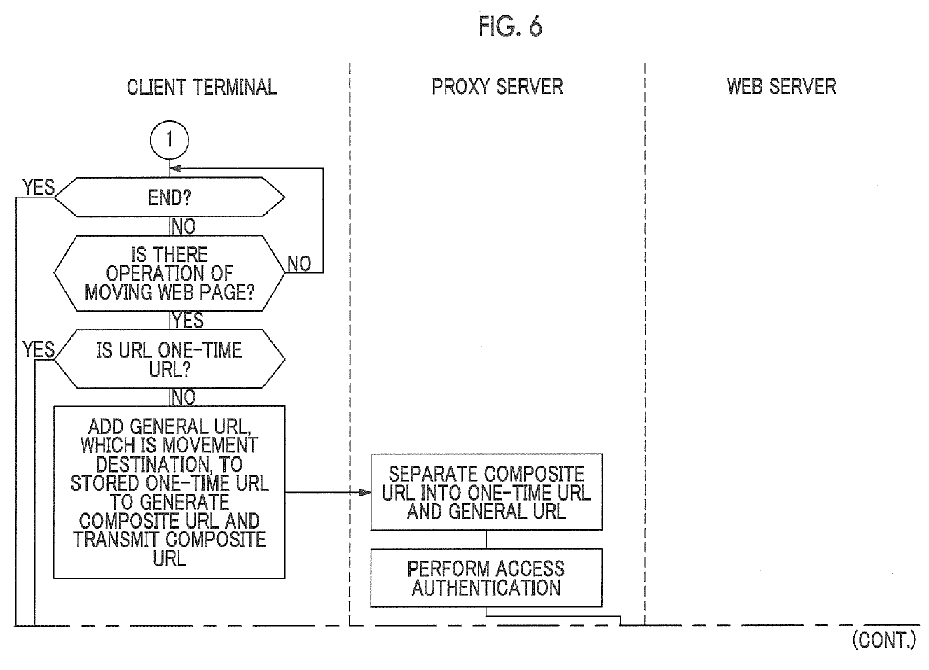

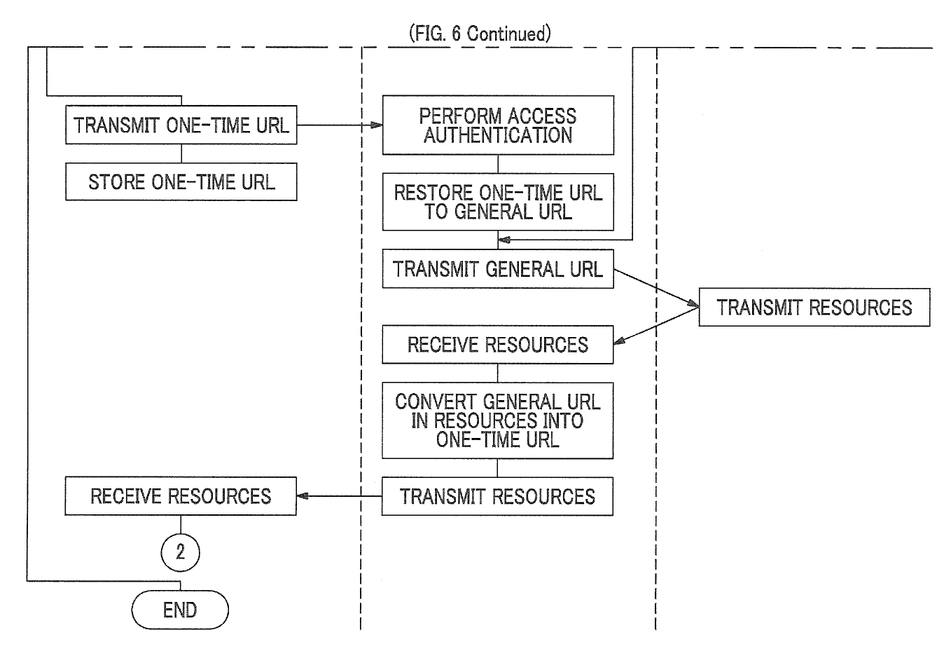

Next, the operation of the above-mentioned structure will be described with reference to FIGS. 5 and 6. When the web page is browsed, first, the client terminal 12 is operated to start the login unit 31, When the login unit 31 starts, the user ID and the password input screen are displayed on the display 12a. The user inputs the user ID and password to the input screen. When the input is completed, the user ID and the password are transmitted as authentication information to the proxy server 14 through the communication unit 30.

The proxy server 14 receives the authentication information through the network 11 and the first FW 16. Then, the login authentication unit 21 performs login authentication using the received authentication information. In the case where it is confirmed that the access user is the authenticated user on the basis of the authentication information, the URL conversion unit 22 converts, for example, the general URL of the initial page which is prepared for the user in advance into the one-time URL.

For example, an encrypted path identifier “id8025822” is generated from the general URL “https://www.bbb.jp/def/index.html” of the initial page and is added to the host identifier “proxy.aaa.jp/” of the proxy server 14 to thereby generate a one-time URL “https://proxy.aaa.jp/id8025822”. Then, the correspondence between the general URL and the encrypted path identifier of the one-time URL is registered in the database 23. In addition, an accessible period that is twenty minutes after the current time is set to the one-time URL and is registered in the database 23 so as to be associated with the encrypted path identifier. Then, the one-time URL is transmitted from the login authentication unit 21 to the client terminal 12 to the first FW 16 and the network 11.

In the client terminal 12, the login unit 31 receives the one-time URL. After the one-time URL is received, the login unit 31 starts the web browser 32 and the web browser 32 outputs the received one-time URL “https://proxy.aaa.jp/id8025822”. Since the determining unit 34 determines that the URL output from the web browser 32 is the one-time URL, the URL is transmitted to the network 11 through the communication unit 30 without being converted into the composite URL. In addition, the one-time URL is stored in the storage unit 36.

As described above, since the host identifier in the one-time URL transmitted from the client terminal 12 indicates the proxy server 14, the one-time URL is normally routed on the network 11 and is received by the proxy server 14. In the proxy server 14, since the URL determining unit 28 determines that the received URL is the one-time URL, the access authentication unit 26 performs access authentication using the one-time URL.

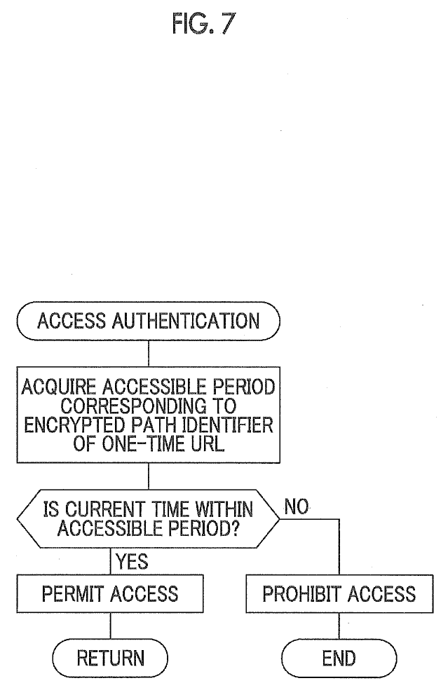

In the access authentication, as shown in FIG. 7, first, the accessible period which is registered in the database 23 in association with the encrypted path identifier in the one-time URL is referred to. Then, in the case where the current date and time are within the accessible period, access is permitted. In the case where the current date and time are outside the accessible period, access is prohibited.

For example, in the case where an access is made within twenty minutes from the generation time of the one-time URL, such access is permitted. In the case where the access is permitted, the URL restoration unit 24 extracts the general URL which is registered in the database 23 in association with the encrypted path identifier from the one-time URL. In this way, the general URL “https://www..bbb.jp/def/index.html” is restored from the one-time URL “https://proxy.aaa.jp/id8025822”. The transfer unit 27 transmits the restored general URL. Since the host identifier in the general URL indicates the web server 15, web server 15 receives the general URL through the second FW 17.

Upon receiving the general URL, the web server 15 reads the resources at the position designated by the path identifier, for example, an HTML, file (index.html) and transmits the HTML file as an HTTPS response to the proxy server 14. The proxy server 14 receives the HTML file which is transmitted as the HTTPS response. Then, the URL conversion unit 22 checks the content of the HTML file. In the case where HTML file has the general URL described therein, the general URL is rewritten to the one-time URL in which the encrypted path identifier obtained by encrypting the general URL is described. In addition, the correspondence between the rewritten general URL and the encrypted path identifier of the one-time URL and the accessible period are registered in the database 23.

After the general URL in the HTML file is rewritten to the one-time URL in the above-mentioned way, the transfer unit 27 transmits the HTML file as an HTTPS response to the client terminal 12 which is the transmission source of the one-time URL.

The web browser 32 receives the HTTPS response through the communication unit 30 and the terminal proxy unit 33. The web browser 32 draws a web page on the basis of the description of the HTML file and displays the web page on the display 12a. Therefore, the web page designated by the general URL “https://www.bbb.jp/def/index.html” is displayed on the display 12a by the transmission of the one-time URL “https://proxy.aaa.jp/id8025822”.

In the case where a URL is described in the HTML file and resources, such as images, are incorporated into the web page, the web browser 32 acquires the resources while the web page is being drawn. Therefore, the web browser 32 outputs the URL of the resources to be acquired. The URL is transmitted to the terminal proxy unit 33 and the determining unit 34 determines whether the URL is the general URL or the one-time URL.

In the case where the URL of the image, which is resources, is described in the HTML file on the web server 15, the URL is originally the general URL and has been rewritten to the one-time URL by the URL conversion unit 22. Therefore, in this case, the web browser 32 outputs the one-time URL and the determining unit 34 determines that the URL is one-time URL. Then, the one-time URL is transmitted from the terminal proxy unit 33 through the communication unit 30. In addition, in this case, the storage unit 36 stores the one-time URL and the stored one-time URL is updated. For example, the one-time URL “https://proxy.aaa.jp/id71448638”is transmitted and is stored in the storage unit 36.

The proxy server 14 receives the one-time URL and the access authentication unit 26 performs access authentication. In this case, as shown in FIG. 7, the access validation period in the database 23 which corresponds to the encrypted path identifier “id71448638” in the one-time URL, for example, “https://proxy.aaa.jp/id71448638” is referred to. In the case where the current date and time are within the accessible period, access is permitted. On the other hand, in the case where the current date and time are outside the accessible period, access is prohibited.

In the case where the access is permitted, the URL restoration unit 24 extracts, for example, the general URL “https://www.bbb.jp/def/image1.jpg” corresponding to the encrypted path identifier “id71448638” of the one-time URL and transmits the general URL to the web server 15. Upon receiving the general URL, the web server 15 reads the resources designated by the path identifier “def/image1.jpg” in the general URL, that is, an image (image1.jpg) and transmits the image as an HTTPS response to the proxy server 14.

The URL conversion unit 22 checks the content of the resources which is received as the HTTPS response by the proxy server 14. Then, the URL conversion unit 22 rewrites the general URL to the one-time URL, similarly to the above, if necessary and registers the one-time URL in the database 23. Then, the transfer unit 27 transmits the resources as an HTTPS response to the client terminal 12.

Then, the web browser 32 receives the HTTPS response from the proxy server 14 and the web page in which the image (image1.jpg) acquired as the HTTPS response is incorporated is displayed.

On the other hand, in the case where, for example, the script described in the HTML file or an external script file is read and executed, the general URL may be output from the web browser. In this case, since the determining unit 34 determines that the URL is the general URL, the conversion unit 35 converts the general URL into the composite URL. In the conversion, first, the one-time URL which is stored in the storage unit 36 at that time is read. Then, the delimiter “?url=” is added to the end of the read one-time URL and the general URL is also added. In this way, the composite URL is generated.

For example, in the case where the general URL “https://www.bbb.jp/def/image1.jpg” is output from the web browser 32 immediately after the one-time URL “https://proxy.aaa.jp/id71448638”is transmitted, “https://proxy.aaa.jp/id71448638?url=https ://www.bbb.jp/def/image2.jpg”is generated as the composite URL. Then, the composite URL is transmitted from the terminal proxy unit 33 through the communication unit 30.

The host identifier of the generated composite URL is “proxy.aaa.jp”. Therefore, the composite URL is normally routed on the network 11 and is then received by the proxy server 14.

When the proxy server 14 receives the URL as above, the URL determining unit 28 determines that the URL is the composite URL. Therefore, the URL separation unit 25 separates the composite URL into the one-time URL and the general URL forming the composite URL. For example, the composite URL “https://proxy.aaa.jp/id71448638?url=https://www.bbb.jp/def/image1.jpg” is separated into the one-time URL “https://proxy.aaa.jp/id71448638”and the general URL “https://www.bbb.jp/def/image1.jpg”.

After the URL is separated, the access authentication unit 26 performs access authentication. In this case, the access authentication uses the one-time URL separated from the composite URL and is performed according to the process shown in FIG. 7, similarly to the above. Therefore, the accessible period in the database 23 which corresponds to the encrypted path identifier “id71448638” in the one-time URL “https://proxy.aaa.jp/id71448638” is referred. In the case where the current date and time are within the accessible period, access is permitted. On the other hand, in the case where the current date and time are outside the accessible period, access is prohibited.

In the case where the access is permitted, the transfer unit 27 transmits the general URL “https://www.bbb.jp/def/image2.jpg” separated from the composite URL. That is, in this case, the general URL separated from the composite URL, not the general URL restored from the one-time URL, is transmitted.

The web server 15 receives the transmitted general URL. Then, the web server 15 reads the resources designated by the path identifier “def/image2.jpg” in the general URL, that is, the image (image2.jpg) and transmits the image as the HTTPS response to the proxy server 14. Then, the image is transferred from the proxy server 14 to the client terminal 12 by the same process as that when the client terminal 12 transmits the one-time URL.

When the client terminal 12 receives the image (image2.jpg), the terminal proxy unit 33 transmits the image (image2.jpg) as the HTTPS response to the general URL “https://www.bbb.jp/def/image2.jpg” to the web browser 32. In this way, the image “image1.jpg” is displayed in the web page.

If necessary, the above-mentioned process is repeatedly performed to display a web page which is an initial page.

For example, in the case where the user touches a link destination in the web page to input an instruction to display a new web page after the initial page is displayed, the web browser 32 outputs a URL designating the instructed new web page. In this case, similarly to when the resources, such as the images in the web page, are acquired, for example, the one-time URL described in the HTML file is output or the general URL is output by, for example, the execution of the script. After the URL is output, the same process as described above is performed by the terminal proxy unit 33 and the proxy server 14.

For example, in the case where the web browser 32 outputs the one-time URL, the one-time URL is transmitted to the proxy server 14. In addition, in this case, the content stored in the storage unit 36 is updated to the one-time URL. Then, the proxy server 14 performs access authentication using the encrypted path identifier in the one-time URL. In the case where the current date and time are within the accessible period and access is permitted, the general URL corresponding to the encrypted path identifier is transmitted to the web server 15. Then, the web server 15 transmits, for example, the HTML file designated by the general URL to the client terminal 12 through the proxy server 14.

On the other hand, in the case where the web browser 32 outputs the general URL, the conversion unit 35 converts the general URL into the composite URL on the basis of the determination result of the determining unit 34. That is, a delimiter and the general URL are added to the last transmitted one-time URL which is stored in the storage unit 36 at that time to generate the composite URL. Then, the composite URL is transmitted to the proxy server 14 and access authentication is performed using the encrypted path identifier in the one-time URL separated from the composite URL, In the case where access is permitted by the access authentication, the general URL separated from the composite URL is transmitted to the web server 15. Then, for example, the HTML file designated by the general URL is transmitted from the web server 15 to the client terminal 12 through the proxy server 14.

In this way, in the case where access is permitted, the display 12a displays the web page corresponding to the one-time URL or the general URL transmitted from the web browser 32. In addition, in the case where, for example, an image is incorporated into the web page, the image is acquired by the same process as described above.

As described above, in the case where the web browser 32 transmits the general URL, the general URL is converted into the composite URL and the composite URL is transmitted to the proxy server 14. Then, access authentication is performed using the one-time URL included in the composite URL. In the case access is permitted, the general URL included in the composite URL is transmitted to the web server 15. Therefore, even in the case where resources are acquired by the general URL which is dynamically generated by the client terminal 12, only the transmission of the composite URL may be performed. Therefore, the resources are rapidly acquired by the general URL with a small volume of communication between the client terminal 12 and the intranet 13. In addition, the composite URL is transmitted to perform access authentication and resource acquisition. Therefore, the resources designated by the general URL are acquired with a small number of communication operations and a small volume of communication.

However, as described above, in the case where the current data and time are outside the accessible period corresponding to the encrypted path identifier, access is prohibited. In the case where the access is denied as above, if the URL received by the proxy server 14 is the one-time URL, the one-time URL is not restored to the general URL and the general URL is not transmitted to the web server 15. If the composite URL is received, the general URL separated from the composite URL is not transmitted to the web server 15. Therefore, in any case, for example, an error is displayed on the client terminal 12 and it is difficult to acquire the resources corresponding to the received one-time URL or general URL.

For example, a person other than the authenticated user may steal the one-time URL used by the user and use the stolen one-time URL to generate the composite URL and performs access. However, since access is available only within the accessible period which is set to the one-time URL included in the composite URL, it is difficult to access the web server 15.

In addition, if an increase in the number of communication operations or the volume of communication is available, the following process may be performed: in the case where the proxy server 14 receives the composite URL and permits access, the proxy server converts the general URL included in the composite URL into the one-time URL and returns the one-time URL to the client terminal 12; and the client terminal 12 transmits the one-time URL to the proxy server 14.

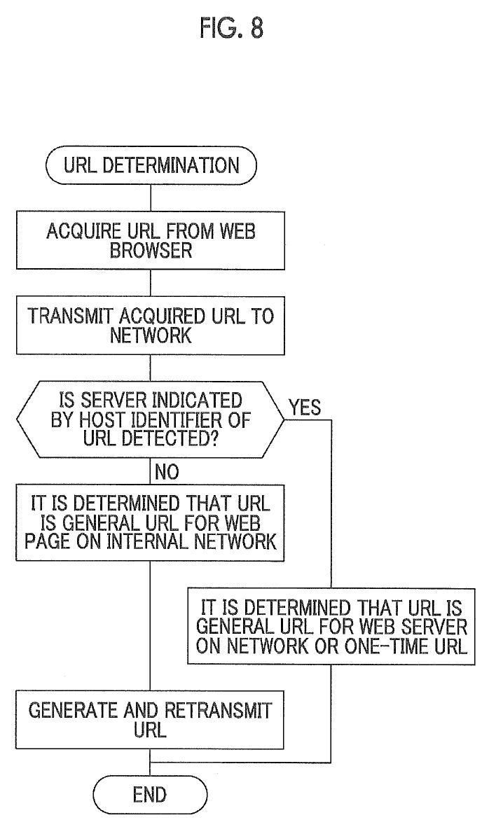

FIG. 8 shows another method of determining the one-time URL and the general URL. This example is based upon an aspect that the web server 15 is not open to the network 11. When the web browser 32 outputs a URL, the determining unit 34 of the terminal proxy unit 33 performs a process of transmitting the URL to the network 11. In a case in which a proper response to the transmission is obtained, i.e., for example, in the case where name resolution is performed for the host identifier (host name) described in the URL by a DNS (Domain Name System) or in the case where a response is obtained from the server with the host identifier described in the URL, the URL is determined to be the one-time URL for the proxy server 14 or the general URL for the web server released to the network 11. In this case, a general process of accessing the web server is continued.

On the other hand, in a case in which the proper response is not obtained, i.e., for example, in the case where the DNS fails to perform name resolution for the host name or in the case where no response is obtained from the server with the host identifier described in the URL, it is determined that the host identifier of the web server 15 which is described in the URL is not open and the URL is the general URL for the web server 15. In this case, a composite URL is generated and transmitted.

According to this example, it is possible to simply respond to the URL of the general web server which is open to the network 11.

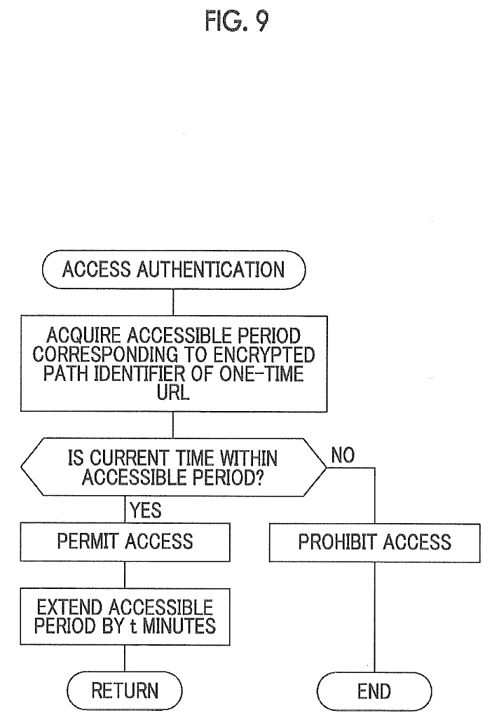

FIG. 9 shows an example of the extension of the accessible period of the one-time URL. In this example, the access authentication unit 26 determines whether there is an accessible period corresponding to the encrypted path identifier in the one-time URL. The access authentication unit 26 extends the accessible period registered in the database 23 by a predetermined time t when access is permitted. In this way, even in the case where the composite URL using the same one-time URL is repeatedly transmitted, it is possible to reduce the possibility that the current date and time will be outside the accessible period and access will be prohibited. In addition, the extension time of the accessible period or the number of extensions may be limited or the accessible period may be extended only in the case where the remainder of the accessible period is less than a predetermined period of time, in order to prevent the accessible period from being extremely long.

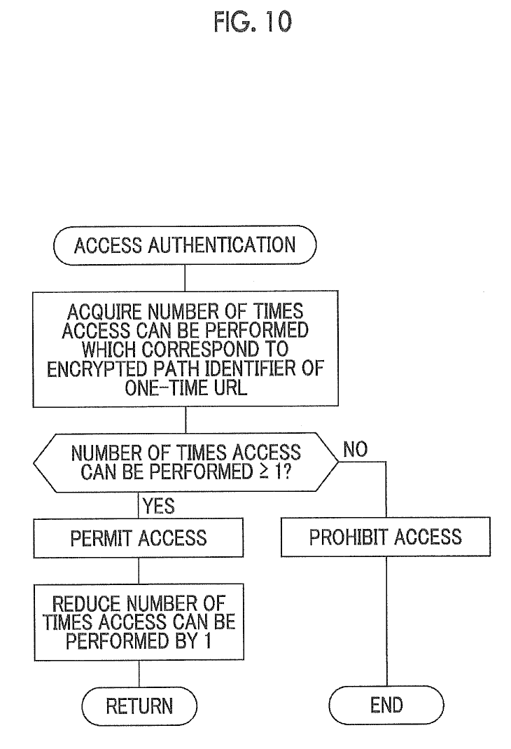

FIG. 10 shows an example in which access to the one-time URL is limited using the number of times access is permitted, instead of the accessible period. In this example, when the encrypted path identifier is generated, the initial value of the number of times access is permitted is registered in the database 23 in association with the encrypted path identifier. As shown in FIG. 10, when access authentication is performed, the number of times access is permitted which corresponds to the encrypted path identifier in the one-time URL is referred to. In the case where the number of times access is permitted is equal to or greater than “1”, access is permitted. In the other cases, access is prohibited. In the case where access is permitted, the number of times access is permitted in the database 23 is updated to a value obtained by reducing the number of times by 1. It is possible to perform accesses corresponding to the initial value of the number of times access is permitted, using the one-time URL and the composite URL using the one-time URL.

In the case where the composite URL is generated using the one-time URL which is used at least once, i.e., for example, in the case where the latest transmitted one-time URL or the URL of the web page which is being displayed is used, the initial value of the number of times access is permitted is set to equal to or greater than 2. In addition, in the case where the one-time URL included in the web page which is being displayed is used to generate the composite URL, access can be performed with the composite URL even though the initial value of the number of times access is permitted is 1. However, it is preferable that the initial value of the number of times access is permitted be equal to or greater than 2, considering that access is performed with the one-time URL.

In the above-described embodiment, one web server is arranged in the second network. However, a plurality of web servers may be arranged. In addition, a proxy server may be arranged instead of the first FW. The second FW may be omitted.

Furthermore, the web browser may display a login authentication input screen and the user ID and password may be transmitted or data may be received from the proxy server, using HTTPS communication, In the above-described embodiment, the HTTPS communication is performed, but the present invention can be applied to other communication systems such as HTTP and FTP.

1. A proxy server apparatus configured to relay communication between a client terminal apparatus on a first network and a web server on a second network, comprising:
a storage unit that stores a correspondence relationship between a one-time URL and a general URL in association with an accessible period during which access using the one-time URL is permitted or a number of times the access is permitted, with respect to each one-time URL, the one-time URL being generated by adding a path identifier generated by encrypting a position of a resource on the web server to a host identifier indicating the proxy server apparatus, the general URL being described so as to directly designate a position of the resource on the web server;
a restoration unit that restores the one-time URL to the general URL corresponding to the one-time URL based upon content stored in the storage unit in a case where a URL included in an access request which is received from the client terminal apparatus is the one-time URL;
a separation unit that, in a case where the URL included in the access request received from the client terminal apparatus is a composite URL, which is generated by adding the general URL to the one-time URL, separates the composite URL into the one-time URL and the general URL;
an access authentication unit that performs access authentication using the one-time URL in a case where the URL included in the access request received from the client terminal apparatus is the one-time URL and using the one-time URL separated from the composite URL by the separation unit in a case where the URL included in the access request is the composite URL, the access authentication unit permitting an access to the web server by the client terminal apparatus in a case where the access request is within the accessible period or the number of times the access is permitted which are stored in the storage unit in association with the one-time URL; and
a transfer unit that transmits to the web server the access request including the general URL restored by the restoration unit or the general URL separated from the composite URL in a case where the access authentication unit permits the access, and that transfers a resource, which is transmitted from the web server in response to the access request, to the client terminal apparatus.

2. The proxy server apparatus according to claim 1,
wherein the storage unit stores the accessible period with respect to each one-time URL, and
wherein the access authentication unit extends the accessible period stored in the storage unit when the access is permitted.

3. A client terminal apparatus configured to access a web server on a second network from a first network through a proxy server apparatus which is provided between the first network and the second network, comprising:
a web browser that outputs an access request including a URL and displays a web page based upon a resource which is transmitted from the web server in response to the access request;
a determining unit that determines whether the URL included in the access request from the web browser is a one-time URL, which is generated by adding a path identifier generated by encrypting a position of the resource on the web server to a host identifier indicating the proxy server apparatus, or a general URL, which is described so as to directly designate the position of the resource on the web server;
a conversion unit that, in a case where the determining unit determines that the URL included in the access request from the web browser is the general URL, converts the access request into an access request including a composite URL, which is generated by adding the general URL to the one-time URL which is estimated to be valid among the one-time URLs acquired prior to determination by the determining unit; and
a transmitting unit that transmits the converted access request in a case where the determining unit determines that the URL included in the access request is the general URL, or transmits the access request including the one-time URL in a case where the determining unit determines that the URL included in the access request is the one-time URL.

4. The client terminal apparatus according to claim 3, further comprising:
a storage unit that stores the one-time URL each time the web browser outputs the access request including the one-time URL,
wherein the conversion unit uses the one-time URL stored in the storage unit as the one-time URL which is estimated to be valid.

5. The client terminal apparatus according to claim 3,
wherein the determining unit transmits the access request including the URL output from the web browser to an external network,
wherein, in a case where the determining unit receives a proper response to the access request transmitted to the external network, the determining unit determines the URL included in the access request to be the one-time URL or a general URL for a server which is open to the external network, and
wherein, in a case where the determining unit does not receive the proper response, the determining unit determines the URL included in the access request to be the general URL for the web server.

6. The client terminal apparatus according to claim 4,
wherein the determining unit transmits the access request including the URL output from the web browser to an external network,
wherein, in a case where the determining unit receives a proper response to the access request transmitted to the external network, the determining unit determines the URL included in the access request to be the one-time URL or a general URL for a server which is open to the external network, and
wherein, in a case where the determining unit does not receive the proper response, the determining unit determines the URL included in the access request to be the general URL for the web server.

7. A remote access system comprising: the proxy server apparatus according to claim 1; and
the client terminal apparatus configured to access a web server on a second network from a first network through a proxy server apparatus which is provided between the first network and the second network, comprising:
a web browser that outputs an access request including a URL and displays a web page based upon a resource which is transmitted from the web server in response to the access request
a determining unit that determines whether the URL included in the access request from
the web browser is a one-time URL, which is generated by adding a path identifier generated by encrypting a position of the resource on the web server to a host identifier indicating the proxy server apparatus, or a general URL, which is described so as to directly designate the position of the resource on the web server;
a conversion unit that, in a case where the determining unit determines that the URL included in the access request from the web browser is the general URL converts the access request into an access request including a composite URL, which is generated by adding the general URL to the one-time URL which is estimated to be valid among the one-time URLs acquired prior to determination by the determining unit; and
a transmitting unit that transmits the converted access request in a case where the determining unit determines that the URL included in the access request is the general URL, or transmits the access request including the one-time URL in a case where the determining unit determines that the URL included in the access request is the one-time URL.

8. A transfer control method for relaying communication between a client terminal apparatus on a first network and a web server on a second network using a proxy server apparatus which is provided between the first network and the second network, comprising:
determining whether a URL included in an access request received from the client terminal apparatus on the first network is a one-time URL, which is generated by adding a path identifier generated by encrypting a position of a resource on the web server to a host identifier indicating the proxy server apparatus, or a composite URL, which is generated by adding a general URL which is described so as to directly designate the position of the resource on the web server to the one-time URL;
restoring the URL included in the access request to the general URL corresponding to the path identifier of the one-time URL in a case where it is determined that the URL included in the access request is the one-time URL;
separating the composite URL into the one-time URL and the general URL in a case where it is determined that the URL included in the access request is the composite URL;
performing access authentication using the one-time URL in a case where it is determined that the URL included in the access request is the one-time URL and using the one-time URL separated from the composite URL in a case where it is determined that the URL is the composite URL so as to permit an access to the web server by the client terminal apparatus in a case where the access request indicates access within an accessible period or a number of times the access is permitted which is set in association with the one-time URL;
transmitting, to the web server, the access request including the general URL restored from the one-time URL or the general URL separated from the composite URL in a case where the access is permitted; and
transferring a resource, which is transmitted from the web server in response to the access request, to the client terminal apparatus.

9. The transfer control method according to claim 8, further comprising:
extending the accessible period when the access is permitted.

10. An access method that allows a client terminal apparatus on a first network to access a web server on a second network through a proxy server apparatus which is provided between the first network and the second network, comprising:
outputting, from a web browser, an access request which includes a URL corresponding to a resource to be acquired;
determining whether the URL included in the access request from the web browser is a one-time URL, which is generated by adding a path identifier generated by encrypting a position of a resource on the web server to a host identifier indicating the proxy server apparatus, or a general URL, which is described so as to directly designate a position of the resource on the web server;
in a case where it is determined that the URL included in the access request is the general URL, converting the access request into an access request including a composite URL, which is generated by adding the general URL to the one-time URL which is acquired prior to the determining and is estimated to be valid; and
transmitting the converted access request in a case where it is determined that the URL included in the access request is the general URL or transmitting the access request including the one-time URL in a case where it is determined that the URL included in the access request is the one-time URL.

11. The access method according to claim 10,
wherein, in the transmitting, a latest one-time URL output from the web browser is used as the one-time URL which is estimated to be valid.

12. The access method according to claim 10,
wherein the determining includes transmitting the access request including the URL output from the web browser to an external network,
wherein, in a case where a proper response to the access request transmitted to the external network is received, it is determined that the URL included in the access request is the one-time URL or a general URL for a server which is open to the external network, and
wherein, in a case where the proper response is not received, it is determined that the URL included in the access request is the general URL for the web server.

13. The access method according to claim 11,
wherein the determining includes transmitting the access request including the URL output from the web browser to an external network,
wherein, in a case where a proper response to the access request transmitted to the external network is received, it is determined that the URL included in the access request is the one-time URL or a general URL for a server which is open to the external network, and
wherein, in a case where the proper response is not received, it is determined that the URL included in the access request is the general URL for the web server.

14. A non-transitory computer-readable recording medium storing a transfer control program for relaying communication between a client terminal apparatus on a first network and a web server on a second network using a proxy server apparatus which is provided between the first network and the second network, the program causing the proxy server apparatus to perform:
determining whether a URL included in an access request received from the client terminal apparatus on the first network is a one-time URL, which is generated by adding a path identifier generated by encrypting a position of a resource on the web server to a host identifier indicating the proxy server apparatus, or a composite URL, which is generated by adding a general URL which is described so as to directly designate the position of the resource on the web server to the one-time URL;
restoring the URL included in the access request to the general URL corresponding to the path identifier of the one-time URL in a case where it is determined that the URL included in the access request is the one-time URL;
separating the composite URL into the one-time URL and the general URL in a case where it is determined that the URL included in the access request is the composite URL;
performing access authentication using the one-time URL in a case where it is determined that the URL included in the access request is the one-time URL and using the one-time URL separated from the composite URL in a case where it is determined that the URL included in the access request is the composite URL, so as to permit an access to the web server by the client terminal apparatus in a case where the access request indicates access within an accessible period or a number of times the access is permitted which is set in association with the one-time URL;
transmitting, to the web server, the access request including the general URL restored from the one-time URL or the general URL separated from the composite URL in a case where the access is permitted; and
transferring a resource which is transmitted from the web server in response to the access request to the client terminal apparatus.

15. The non-transitory computer-readable recording medium storing the transfer control program according to claim 14,
wherein the transfer control program causes the proxy server apparatus to further perform extending the accessible period when the access is permitted.

16. A non-transitory computer-readable recording medium storing an access program that allows a client terminal apparatus on a first network to access a web server on a second network through a proxy server apparatus which is provided between the first network and the second network, the access program causing the client terminal apparatus to perform:
outputting, from a web browser, an access request which includes a URL corresponding to a resource to be acquired;
determining whether the URL included in the access request from the web browser is a one-time URL, which is generated by adding a path identifier generated by encrypting a position of a resource on the web server to a host identifier indicating the proxy server apparatus, or a general URL, which is described so as to directly designate a position of the resource on the web server;
in a case where it is determined that the URL included in the access request is the general URL, converting the access request into an access request including a composite URL generated by adding the general URL to the one-time URL which is acquired prior to the determining and is estimated to be valid; and
transmitting the converted access request in a case where it is determined that the URL included in the access request is the general URL or transmitting the access request including the one-time URL in a case where it is determined that the URL included in the access request is the one-time URL.

17. The non-transitory computer-readable recording medium storing the access program according to claim 16,
wherein, in the transmitting, a latest one-time URL output from the web browser is used as the one-time URL which is estimated to be valid.

18. The non-transitory computer-readable recording medium storing the access program according to claim 16, the access program causing the client terminal apparatus to perform:
in the determining, transmitting the access request including the URL output from the WEB browser to an external network;
in a case where a proper response to the access request transmitted to the external network is received, determining that the URL included in the access request is the one-time URL or a general URL for a server which is open to the external network; and
in a case where the proper response is not received, determining that the URL included in the access request is the general URL for the web server.

19. The non-transitory computer-readable recording medium storing the access program according to claim 17, the access program causing the client terminal apparatus to perform:
in the determining, transmitting the access request including the URL output from the WEB browser to an external network;
in a case where a proper response to the access request transmitted to the external network is received, determining that the URL included in the access request is the one-time URL or a general URL for a server which is open to the external network; and
in a case where the proper response is not received, determining that the URL included in the access request is the general URL for the web server.
